(19) United States
(12) Patent Application Publication
(10) Pub. No.: US 2022/0333413 A1
(43) Pub. Date: Oct. 20, 2022

(54) Arrangement of a First Component on a Second Component of a Motor Vehicle and Motor Vehicle

(71) Applicant: Mercedes-Benz Group AG, Stuttgart (DE)

(72) Inventors: Jan HEYDUCK, Sindelfingen (DE); Tobias KONRAD, Boeblingen (DE); Martin LINDMAYER, Sulz (DE)

(21) Appl. No.: 17/762,644

(22) PCT Filed: Aug. 6, 2020
(86) PCT No.: PCT/EP2020/072101

§ 371 Date: Mar. 22, 2022

(30) Foreign Application Priority Data
Sep. 23, 2019 (DE) 10 2019 006 671.5

(51) Int. Cl. E05B 85/10

(52) U.S. Cl. CPC E05B 85/10

(57) ABSTRACT

An arrangement of a motor vehicle includes a first component and a second component where the first component and the second component are disposed at a spacing vertically offset with respect to one another. The first component has a first edge with a first outer radius in a first border region and the second component has a second edge with a second outer radius in a second border region. The first and second border regions are adjacent, the first outer radius equals the second outer radius, and the first outer radius and the second outer radius correspond to at least, or exactly, the spacing.

### BACKGROUND AND SUMMARY OF THE INVENTION

The invention relates to an arrangement of a first component on a second component of a motor vehicle. The invention also relates to a motor vehicle, in particular a car.

Such an arrangement of a first component on a second component of a motor vehicle is known from DE 10 2013 215 896 A1. In the arrangement, the components are arranged, in particular in at least one respective position of the components relative to one another, at a spacing vertically offset with respect to one another, also referred to as a height offset.

In such arrangements, a joint pattern is usually produced which has at least one joint or at least one gap between the components. If the components are aligned unfavourably with respect to one another, then the joint pattern appears unattractive to persons viewing the respective arrangement. This may, in particular, be based on the fact that the joint or the gap is of uneven width and/or the joint or gap of the joint pattern are of uneven widths between them. Very elaborate and therefore time-consuming and expensive tolerance considerations and centring processes are usually required in order to avoid such visually unfavourable joint patterns. This is particularly the case where the components are components which lie in the respective field of view of persons who are outside the motor vehicle and can therefore be seen, that is to say can be viewed. In particular, the joint pattern may appear unattractive when the person in question changes position.

DE 10 2018 100 528 A1 discloses a motor vehicle door which is provided with a recess into which is set a door handle which protrudes beyond the outside of the door. The door handle has an outer radius at its border region facing towards the border edge region of the recess, whilst the recess has a distinct border edge from which a curved abutment surface for the door handle extends inwards into the door.

The problem underlying the present invention is to provide an arrangement and a motor vehicle so that a joint pattern which is particularly advantageous from a visual perspective can be produced in a particularly simple way.

In the arrangement of a first component on a second component of a motor vehicle preferably configured as a car, in particular as a passenger car, according to the invention, the components are arranged at a spacing vertically offset with respect to one another, also referred to as a height offset.

In order now to be able to produce, in a particularly simple and therefore time-efficient and/or inexpensive way, a joint pattern which is particularly advantageous from a visual perspective and, for example, can be or is produced or is formed through the components, provision is made according to the invention for the components each to have, in their border regions which are adjacent to one another, in particular directly adjacent to one another, an edge provided with an outer radius, wherein the two outer radii are the same and in each case correspond to at least or exactly the spacing, that is to say the height offset. The feature that the border regions are adjacent to one another, in particular directly adjacent to one another, is to be understood, in particular, to mean that the border regions are arranged on sides of the components facing directly towards one another. This means that the radius of the first component is arranged on a first side of the first component, the first side thereof facing directly or straight towards the second component. The radius of the second component is arranged on a second side of the second component, the second side thereof facing straight or directly towards the first component. This is to be understood, in particular, as meaning that no other components or parts are arranged between the sides and therefore between the radii.

Provision can be made for the components, also referred to as parts, to be attached at least indirectly, in particular directly, to one another so that the components cannot move relative to one another, in particular in the fully produced state of the arrangement or of the motor vehicle. It is also conceivable, in particular in the fully produced state of the motor vehicle, for the components to be moveable relative to one another, in particular translationally and/or rotationally. The feature that the components are arranged vertically offset with respect to one another in the spacing and that the border regions each have the same radius which corresponds at least or exactly to the spacing, can be understood to mean that the parts (components) are arranged vertically offset with respect to one another in the spacing in at least one position of the components relative to one another and the border regions have the same radius corresponding at least or exactly to the spacing. This position is preferably an end position of the components which, for example, adopt the end position, in particular independently or automatically, if no external forces are acting on the components.

Because the radii of the border regions are configured to be congruent to the parts mentioned, the person can be guaranteed an identical or the identical appearance of the arrangement from any viewing angle from which, for example, a person who is outside the motor vehicle and therefore in an area around the motor vehicle views the arrangement and therefore the parts. This can be understood, in particular, to mean that a visually particularly advantageous joint pattern can be produced from any viewing angle without this requiring time-consuming and expensive tolerance considerations and centring measures or alignment measures. In particular, the invention can produce a visual joint indifference through a parallel axis, that is to say through what is referred to as the parallel axis effect. This means that the invention uses what is referred to as the parallel axis so that the same joint pattern is produced from at least virtually every viewing angle. Damage to the overall visual impression of the arrangement through the visual errors described can therefore be avoided. In particular, the invention enables a person's line of sight, in particular that of a viewer visually perceiving the arrangement from outside the motor vehicle, not to be able to discern any clear exposed edge. The human brain is therefore artificially tricked over the recognizability of a joint pattern. The arrangement according to the invention is therefore impervious to the joint pattern and, in particular, to visual errors or visually negative effects which might result from changes in the position of a viewer of the arrangement relative to the parts, so the person gets the same visually positive impression of the arrangement from every viewing angle. Consequently, compared to conventional solutions, a higher level of perceived value can be achieved and excessive time-consuming and expensive adjustment processes and/or tolerance balancing elements are avoided or are no longer required. The parts can also, for example, be produced easily in particularly high numbers. The arrangement is therefore non-critical owing to tool washout over a respective part life cycle.

In order to be able to produce a particularly advantageous visual impression of the arrangement in a particularly easy way, provision is made, in one embodiment of the invention, for a further sub-region of the component having the at least one border region to border at least one of the border regions, wherein the further sub-region is configured to be convex and is thereby configured to be raised compared to the at least one border region, in other words as a projection. The further sub-region is therefore an arching, in particular a planar and/or slight arching, of the component having the at least one border region, in particular compared to the component having the radius of the at least one border region. The arching is provided, for example, in the vertical direction of the vehicle and in the transverse direction of the vehicle and is, in particular in the vertical direction of the vehicle and in the transverse direction of the vehicle, a multiple of the radius.

It has further been shown to be particularly advantageous for the components to be arranged vertically offset with respect to one another in a first direction in the spacing. The first direction runs, for example, in the transverse direction of the vehicle.

It has been shown to be particularly advantageous here for at least the border regions in a second direction running perpendicularly to the first direction to be spaced apart from one another and to be adjacent to one another in the second direction. In particular, the parts are at least partially, in particular at least predominantly or entirely, spaced apart from one another in the second direction. As a result, a visually particularly advantageous joint pattern can easily be presented.

It has further been shown to be particularly advantageous here for the respective radius to have two ends spaced apart from one another in the first direction and to extend continuously from a first of the ends to the second end. As a result, a particularly advantageous visual impression of the arrangement can be guaranteed.

In order to be able to configure the arrangement or its visual impression particularly robustly here with respect to changes in the position of a viewer of the arrangement relative to the arrangement, provision is made in a further embodiment of the invention for the spacing to be a spacing running in the first direction between that end of the radius of the first component spaced furthest apart from the radius of the second component in the first direction and that end of the radius of the second component arranged nearest to the radius of the first component in the first direction.

In order to be able to arrange the parts particularly advantageously relative to one another and consequently produce a particularly advantageous visual impression of the arrangement in a particularly easy way, provision is made in a further configuration of the invention for the border region of the second component to delimit at least a portion of a recess of the second component, wherein the first component is arranged partially in the recess and protrudes from the recess, in particular in the first direction. Provision is preferably made here for the first component to be the part which has the at least one border region and therefore the further sub-region.

A further embodiment is distinguished by the fact that the border region of the first component and therefore the radius of the border region of the first component is arranged, in particular entirely, outside the recess, also referred to as a slot, thus giving a particularly advantageous visual impression.

Finally, it has been shown to be particularly advantageous for the second component to be a panelling element of a door, in particular of a side door, and for the first component to be a door handle of the door of the motor vehicle. This embodiment is based on the realization that, conventionally, in particular, a joint pattern formed through an external door handle and a panelling element of a door, in particular of a side door, of a car preferably configured as a passenger car, is extremely critical with respect to any visual errors, so, in particular, external handles of doors have to be positioned relative to panelling elements of doors in a time-consuming and expensive way. This can now be avoided through the invention.

The second part is preferably an external handle of the door, wherein the panelling element is preferably an external panelling element and therefore forms at least part of the outer skin of the motor vehicle. By means of the door handle, for example, a door lock of the door can be unlocked in order then to open the door.

The invention also includes a motor vehicle preferably configured as a car, in particular as a passenger car, which comprises at least one arrangement according to the invention. Advantages and advantageous configurations of the arrangement according to the invention are to be regarded as advantages and advantageous configurations of the motor vehicle according to the invention and vice versa.

Further advantages and details of the invention are set out in the following description of preferred exemplary embodiments and by reference to the drawings. The features and feature combinations specified in the description above and the features and feature combinations mentioned in the description of the figures and/or shown in the figures alone below can be used not only in the combination specified in each case, but also in other combinations or on their own without falling outside the scope of the invention.

### BRIEF DESCRIPTION OF THE DRAWINGS

FIG. 1 shows a schematic front view of an arrangement according to the invention of a first component on a second component of a motor vehicle according to a first embodiment, wherein the components are arranged at a spacing vertically offset with respect to one another and each have, in their adjacent border regions, the same radius which corresponds to at least or exactly the spacing;

FIG. 2 shows, in the form of an excerpt, a schematic sectional view through the arrangement according to FIG. 1 along a sectional line X-X shown in FIG. 1;

FIG. 3 shows a schematic plan view of the arrangement according to a second embodiment;

FIG. 4 shows, in the form of an excerpt, a schematic sectional view through the arrangement according to FIG. 3 along a sectional line B-B shown in FIG. 3;

FIG. 5 shows, in the form of an excerpt, a further schematic sectional view through the arrangement according to FIG. 4;

FIG. 6 shows, in the form of an excerpt, a schematic sectional view through the arrangement according to FIG. 3 along a sectional line A-A shown in FIG. 3;

FIG. 7 shows, in the form of an excerpt, a further schematic sectional view through the arrangement according to FIG. 6; and

FIG. 8 shows, in the form of an excerpt, a schematic perspective view of the arrangement according to a third embodiment.

### DETAILED DESCRIPTION OF THE DRAWINGS

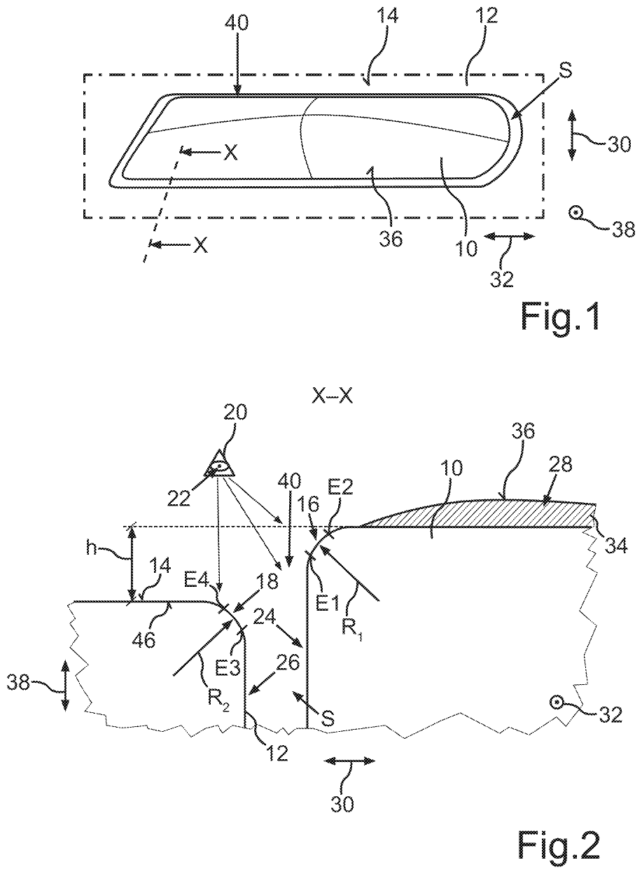

FIG. 1 shows a schematic front view of an arrangement of a first component in the form of a door handle 10 on a second component in the form of a panelling element 12 of a motor vehicle. In the arrangement, the door handle 10 is arranged on the panelling element 12 or vice versa. The door handle 10 and the panelling element 12 are components of a door of the motor vehicle configured, for example, as a side door. The motor vehicle is preferably configured as a car, in particular as a passenger car, and comprises, in its fully produced state, a structure preferably configured as a self-supporting body. The abovementioned door is held movably, in particular pivotably, on the structure here and can be moved between a closed position and at least one open position relative to the structure. In the closed position, the door closes at least one sub-region of a door opening delimited by the structure, the door freeing the sub-region in the open position. For example, the door has a door lock here by means of which the door can be locked or secured relative to the structure in the closed position. The door handle 10 is preferably an external handle of the door here which, in the closed position of the door, is arranged outside the interior of the motor vehicle and, for example, is arranged on an outer side of the door or panelling element 12 facing away from the interior here, in particular outwardly in the transverse direction of the vehicle. The panelling element 12 is an external panelling element here which forms at least part of an outer skin 14 of the door. The outer skin 14 can be visually and haptically perceived by a person outside and therefore in an area around the motor vehicle. The person can, for example, take hold of the door handle 10 with their hand and at least partially grip it and then exert an external force, in particular a tensile force, on the door handle 10. The person can hereby move the door handle 10, in particular translationally and/or rotationally, for example, from a position shown in FIG. 1 and also referred to as an end position or final position, relative to the panelling element into at least one actuation position differing from the end position. The person can hereby unlock the door lock and then move the door from the closed position into the open position relative to the structure. If the person releases the door handle 10 so that, for example, no external forces are acting on the door handle 10 and on the panelling element 12, then, for example, the door handle 10 moves independently or automatically from the actuation position back into the end position. The door handle 10 therefore adopts the end position if no external forces are acting on the components, the door handle 10, for example, being at rest relative to the panelling element 12 in the end position. For example, the door handle 10 is moved from the actuation position into the end position relative to the panelling element 12 by means of a reset device. For this purpose, the reset device comprises, for example, at least one spring element and/or a motor, in particular an electric motor.

Unless otherwise specified, the following statements relate, in particular, to the final position of the door handle 10 relative to the panelling element 12. Therefore, for example, the door handle 10 is in the final position in the figures. In other words, for example, the figures show the door handle 10 in the final position. FIGS. 1 and 2 also show a first embodiment of the arrangement according to the invention.

In the arrangement, the components, also referred to as parts, are arranged, at least in the final position, at a spacing vertically offset with respect to one another, also referred to as a height offset. In order to be able to guarantee a visually particularly advantageous joint pattern formed through the components, at least in the final position, in a particularly easy and therefore quick and inexpensive way here, provision is further made for the components (the door handle 10 and the panelling element 12) each to have the same radius R₁ and R₂ respectively in their border regions 16 and 18 which are directly or immediately adjacent to one another and which, for example, form respective, rounded edges or corners of the components. This means that the border region 16 of the door handle 10 has the radius R₁, the border region 18 of the panelling element 12 having the radius R₂, where:

R₁=R₂.

The radii R₁ and R₂ respectively also correspond at least or exactly to the spacing h, also referred to as the height offset. In other words:

R₁=R₂≤h.

Particularly preferably:

R₁=R₂=h.

It need merely be stated that the radii R₁ and R₂ are therefore outer radii. These outer radii correspondingly round off the respective edge in the border region of the first and second components 10, 12. These edges or these outer radii are located exactly where two side surfaces of the first component 10 and of the second component 12 respectively butt against one another.

FIG. 2 shows a viewer of the arrangement in particularly schematic form and designated by the number 20. The viewer is, for example, outside the motor vehicle and therefore in an area surrounding it and is viewing the arrangement. The viewer 20 is, for example, the abovementioned person. In FIG. 2, respective arrows coming from the viewer 20, in particular from their eyes 22, illustrate lines of sight and therefore at least one viewing angle from which the viewer 20 is viewing the arrangement and, in particular, the joint pattern.

The feature that the border regions 16 and 18 are adjacent to one another, in particular immediately or directly adjacent to one another, is to be understood, in particular, as meaning that the border region 16 is arranged on a first side 24 of the door handle 10, the side 24 facing directly towards the panelling element 12. The border region 18 is arranged here on a side 26 of the panelling element 12, the side 26 thereof facing directly towards the side 24 or the door handle 10. This means, in particular, that no other parts or components are arranged between the sides 24 and 26.

In the exemplary embodiment shown in the figures, the sides 24, 26, at least in the region of the gap S or of the joint between the components 10, 12, each have a planar side surface—according to the sectional representation in FIG. 2—which—as can be seen in FIG. 2—run parallel to one another. To form an edge which is provided with the outer radius according to the invention, the first component 10 has a side surface which is configured to be planar in its region near the border edge, but can be configured to be arched according to another exemplary embodiment not shown in the figures. The second component 12 likewise has a side surface running into or adjoining the border edge region which is configured to be planar in the exemplary embodiment according to FIG. 2 here and is formed by the outer skin 14.

In order to be able to produce a particularly advantageous visual impression of the arrangement, a further sub-region 28 of the door handle 10 borders the border region 16 of the door handle 10. The sub-region 28 is configured to be convex here and thereby raised compared to the border region 16, that is to say slightly arched. In FIGS. 1 and 2, the vertical direction of the vehicle, also designated by the letter z, is illustrated by a double arrow 30 and a double arrow 32 illustrates the longitudinal direction of the vehicle, also designated by the letter x. Provision is made here, in particular, for the door handle 10, in particular its handle upper part 34 respectively forming or having the border region 16 and the further sub-region 28 thereof, to be arched in the longitudinal direction of the vehicle and in the transverse direction of the vehicle, in particular forming the convex sub-region 28. Again in other words, the sub-region 28 is an arching, in particular a planar arching, which is vaulted or arched in the x and z directions. The arching, in particular the planar arching, is a multiple of the radius R₁ or R₂ respectively in the longitudinal direction of the vehicle and in the vertical direction of the vehicle here. The arching or the sub-region 28 forms an arched or vaulted surface 36, which is also designated as a visible surface or top surface, in particular of the door handle 10. The surface 36 can be visually and haptically perceived by the abovementioned viewer here.

As can be seen from FIG. 2, the components are arranged vertically offset with respect to one another along or in a first direction illustrated by a double arrow 38 in FIG. 2 so that the spacing h (height offset) runs along the first direction or in the first direction. With respect to the final position of the door handle 10 relative to the panelling element 12 and with respect to the closed position of the door, for example, the first direction illustrated by the double arrow runs in the transverse direction of the vehicle which is also designated as the y direction. The components are at least partially spaced apart from one another in a second direction running perpendicularly to the first direction and illustrated by the double arrow 30 such that at least the border regions 16 and 18 are spaced apart from one another in the second direction. With respect to the final position and with respect to the closed position, the second direction runs, for example, in the vertical direction of the vehicle. The border regions 16 and 18 are adjacent to one another in the second direction here.

The radii R₁ and R₂ respectively each have exactly two ends E1 and E2, and E3 and E4, the radii R₁ and R₂ respectively extending continuously from a first of the ends E1 and E2 or E3 and E4 and therefore without interruption as far as the other end E2 or E4 respectively. This means that the radius R₁ extends continuously from the end E1 to the end E2 or vice versa, and the radius R₂ extends continuously from the end E3 to the end E4 or vice versa. The end E4 is arranged nearer to the radius R₁ in the first direction than the end E3, and the end E2 is spaced apart further from the radius R₂ in the first direction than the end E1. The spacing h is now the or a spacing running in the first direction between that end E2 of the radius R₁ of the door handle 10 spaced furthest apart from the radius R₂ of the panelling element 12 in the first direction and that end E4 of the radius R₂ of the panelling element 12 arranged nearest to the radius R₁ of the door handle 10 in the first direction.

It need merely be stated that the end E1 forms the transition point or transition area at which the radius R₁ passes into the surface of the side 24, whilst the radius R₁ passes into the outer surface of the component 10 at the end E2. The same is the case with the ends E3 and E4. The end E3 marks the transition point/area at which the radius R₂ passes into the surface of the side 26 and the end E4 marks the transition point/area between the radius R₂ and the outer skin 14 of the component 12.

As can be seen in FIG. 2, the components are spaced apart from one another both in the vertical direction of the vehicle and in the longitudinal direction of the vehicle so that a joint configured, in particular, as a gap S, is formed between the components. The gap S is delimited by the components on both sides here and extends, for example, in a circumferential direction of the door handle 10 entirely or without interruption around the door handle 10. The panelling element 12 also has a recess 40, also referred to as a slot, which is at least partially delimited by the border region 18. At least in the final position, the door handle 10 is arranged partially in the recess 40 here, the door handle 10 protruding from the recess 40 at least in the final position. The border region 16 and therefore the radius R₁ are arranged entirely outside the recess 40 here.

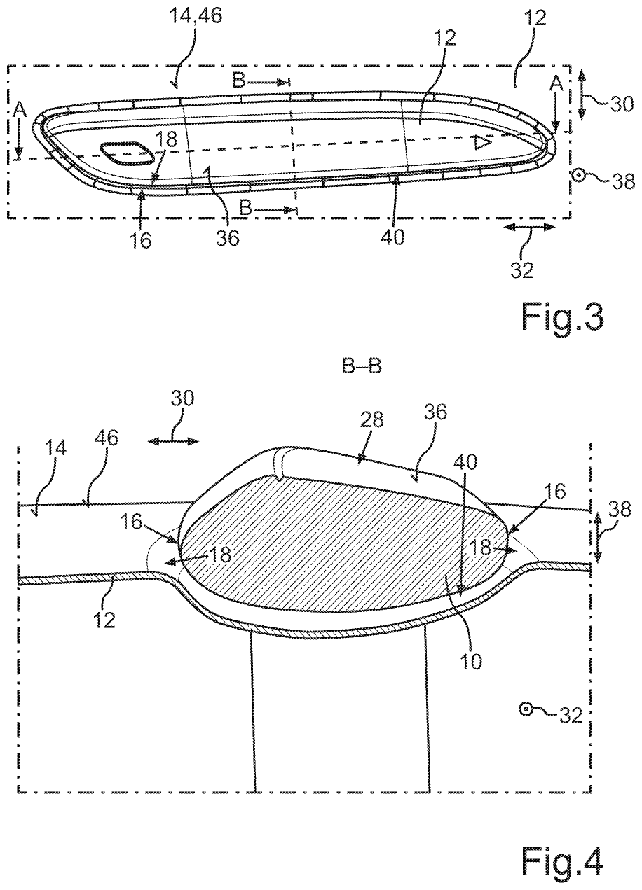

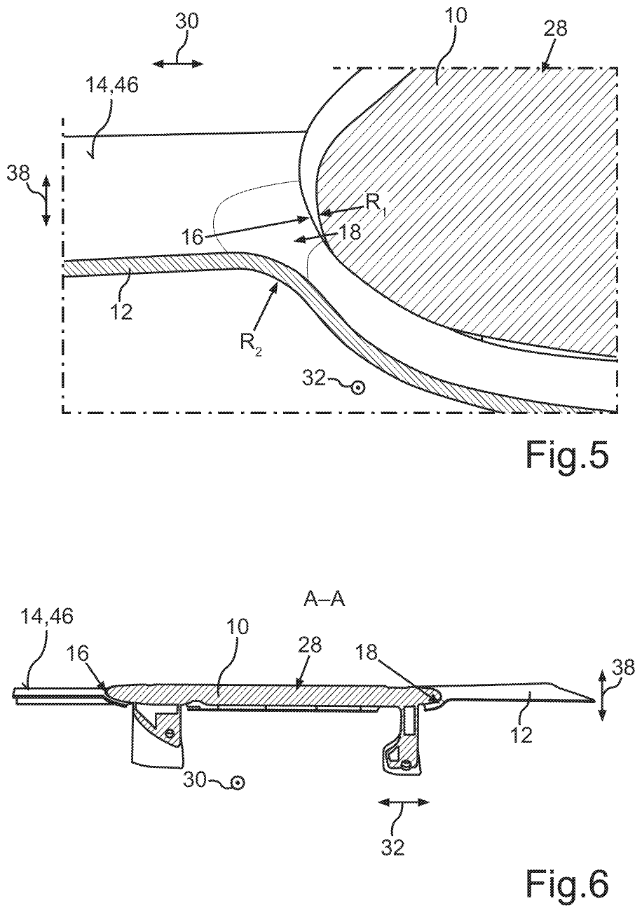

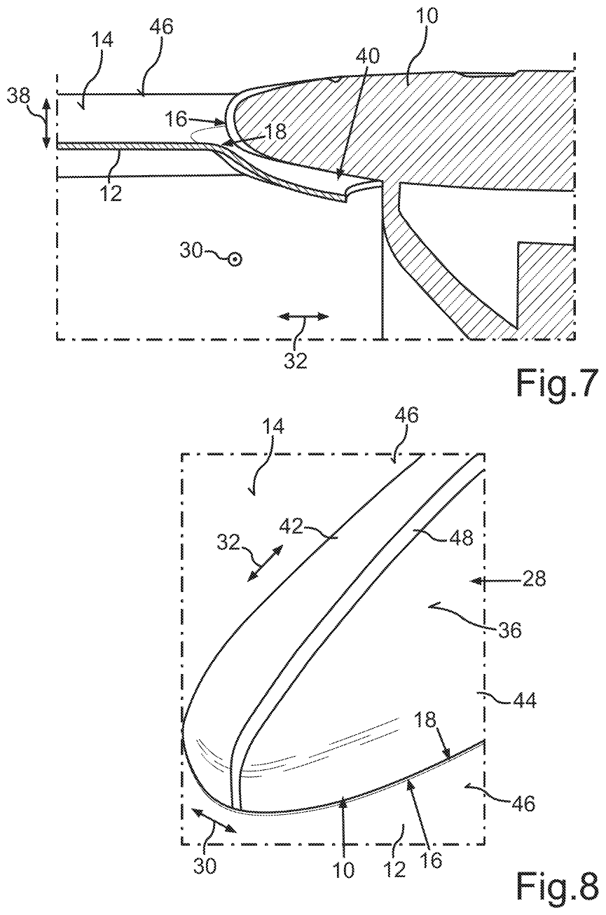

FIGS. 3 to 7 show a second embodiment of the arrangement. The arching, that is to say the vaulted or arched sub-region 28, can be seen particularly clearly in FIGS. 3 and 4. The recess 40 can also be seen particularly clearly in FIG. 4. It is also particularly clear from FIGS. 3 to 7 that the previous and subsequent statements can be transferred both to a cross section of the arrangement and therefore of the components which extends in a plane stretched through the vertical direction of the vehicle in the transverse direction of the vehicle and which can be seen, for example, in FIGS. 2, 4 and 5, and to a cross section of the arrangement and therefore of the components which extends in a plane stretched through the longitudinal direction of the vehicle and the transverse direction of the vehicle and which can be seen, for example, in FIGS. 6 and 7.

Finally, in the form of an excerpt, FIG. 8 shows a third embodiment of the arrangement in a schematic perspective view. The door handle 10 can be configured as a single-shell door handle which, for example, has a single-shell handle body. Provision is therefore made, for example, for exactly one shell configured, in particular, in one piece which, for example, forms the border region 16 and the sub-region 28 and therefore the surface 36.

As an alternative thereto, it is also conceivable for the door handle 10 to have at least or exactly two shell elements 42 and 44 which are configured, for example, as half-shells. The shell elements 42 and 44 are configured, for example, separately from one another and are connected at least indirectly to one another. For example, the shell element 42 is arranged above the shell element 44 in the vertical direction of the vehicle so that, for example, the shell element 42 is an upper shell and the shell element 44 is a lower shell. The shell elements 42 and 44 respectively are preferably configured in one piece.

For example, the shell elements 42 and 44 form respective parts of the border region 16 and of the sub-region 28 and therefore the surface 36 here. For example, the shell elements 42 and 44 differ in their upper surfaces and, in particular, in the colours of the surfaces which, for example, are or form respective parts of the surface 36. For example, the surface of the shell element 42 can be formed from chrome or be chrome coloured, whilst, for example, the colour of the shell element 44 or the colour of the surface of the shell element 44 corresponds to the colour of a surface 46 of the panelling element 12 configured as a visible side and therefore, for example, the colour of the car. Illustrated particularly schematically in FIG. 8 here is a joint 48, also referred to as a parting line, along which, for example, the shell elements 42 and 44 are arranged on one another or attached to one another and assembled.

1.-10. (canceled)

11. An arrangement of a motor vehicle, comprising:
a first component; and
a second component, wherein the first component and the second component are disposed at a spacing vertically offset with respect to one another;
wherein the first component has a first edge with a first outer radius in a first border region and the second component has a second edge with a second outer radius in a second border region, wherein the first and second border regions are adjacent, wherein the first outer radius equals the second outer radius, and wherein the first outer radius and the second outer radius correspond to at least, or exactly, the spacing.

12. The arrangement according to claim 11, wherein the first component has a sub-region that borders at least one of the first and second border regions and wherein the sub-region is convex such that the sub-region is raised compared to the first border region.

13. The arrangement according to claim 11, wherein the first and second components are disposed vertically offset with respect to one another in a first direction in the spacing.

14. The arrangement according to claim 13, wherein at least the first and second border regions in a second direction running perpendicularly to the first direction are spaced apart from one another and are adjacent to one another in the second direction.

15. The arrangement according to claim 11, wherein each of the first outer radius and the second outer radius has a respective first end and a second end spaced apart from one another in the first direction and wherein each of the first outer radius and the second outer radius extends continuously from the respective first end to the second end.

16. The arrangement according to claim 15, wherein the spacing runs in the first direction between 1) the second end of the first outer radius of the first component which is spaced furthest apart from the second outer radius of the second component in the first direction and 2) the second end of the second outer radius of the second component which is disposed nearest to the first outer radius of the first component in the first direction.

17. The arrangement according to claim 11, wherein the second border region of the second component delimits at least a portion of a recess of the second component and wherein the first component is disposed partially in the recess and protrudes from the recess.

18. The arrangement according to claim 17, wherein the first border region of the first component is disposed outside the recess.

19. The arrangement according to claim 11, wherein the first component is a door handle of a door of the motor vehicle and the second component is a panelling element of the door of the motor vehicle.

20. A motor vehicle, comprising:
the arrangement according to claim 11.
